(19) United States
(12) Patent Application Publication
(10) Pub. No.: US 2006/0186235 A1
(43) Pub. Date: Aug. 24, 2006

(54) Method for refining paper or cellulose fibers in an aqueous suspension

(75) Inventors: Michael Kramer, Weingarten (DE); Klaus Doelle, Kisslegg (DE); Volker Niggl, Weingarten (DE); Paul-Wilhelm Sepke, Berg (DE); Hermann Kleinschnittger, Weingarten (DE); Gerhard Gaus, Wolpertswende (DE); Herbert Holik, Ravensburg (DE)

Correspondence Address: TAYLOR & AUST, P.C., 142 SOUTH MAIN STREET, P. O. BOX 560, AVILLA, IN, 46710, US

(73) Assignee: VOITH PAPER PATENT GMBH, Heidenheim (DE)

(21) Appl. No.: 10/565,490

(22) PCT Filed: Jul. 21, 2004
(86) PCT No.: PCT/EP04/08124

§ 371 Date: Mar. 7, 2006

(30) Foreign Application Priority Data
Aug. 18, 2003 (DE) 103 37 922.3
Aug. 18, 2003 (DE) 103 37 921.5

(51) Int. Cl. B02C 21/00

(52) U.S. Cl. 241/21; 241/228

(57) ABSTRACT

A method for refining aqueous suspended fibers, the fibers being paper fibers or pulp fibers including the steps of leading, pressing, forming, temporarily attaching, supplying and discharging. The leading step includes leading the aqueous suspended fibers through at least one refining zone which is located between an inside wall of a rotating refiner drum and at least one refiner roll, the refiner roll rotating in association with the refiner drum. The pressing step includes pressing the refiner roll and the refiner drum against each other thereby causing a mechanical refining force to be transferred to the fibers so that strength properties of paper produced therefrom are altered. The forming step includes forming a fibrous stock layer on the inside wall of the rotating refiner by the aqueous suspended paper fibers. The temporarily attaching step includes temporarily attaching the fibrous stock layer to the inside wall due to rotation. The supplying step includes supplying a continuous flow of liquid with the aqueous suspended paper fibers to the fibrous stock layer. The discharging step includes discharging the liquid from the fibrous stock layer.

### BACKGROUND OF THE INVENTION

1. Field of the Invention

The present invention relates to a method of refining an aqueous suspension of fibers, and, more particularly to a method of refining an aqueous suspension of paper or pulp fibers.

2. Description of the Related Art

It has been known for a long time that pulp fibers must be refined so that the subsequently produced paper possesses the desired characteristics, especially the characteristics relating to strength, formation and surface. The most commonly used refining methods utilize refining surfaces that are equipped with refiner bars. The appropriate machines are usually referred to as bar refiners. For special applications refining processes are also used where at least one refiner surface is knife (bar) free, so that the refining action is transferred through friction or shear forces.

The effect of the process can be controlled within a wide range by changing the refining parameters, whereby in addition to the height of the refining level, it can be especially distinguished as to whether a stronger cutting or stronger fibrillated refining is desired. If pulp fibers are being processed by way of known refining processes, then their dewatering resistance increases with increasing refining level. A common measure for the dewatering resistance is the freeness according to Schopper-Riegler. An increase in the freeness value negatively affects the sheet formation in the paper machine. It is however accepted, since the above mentioned quality characteristics of the pulp play a predominant role for its usability. In many instances the refining parameters are selected so that the refining value increase that is required to achieve the desired fiber quality is as low as possible. This sphere of influence is however very limited. In addition, this may adversely affect the power efficiency of the refining process.

Germany Patent No. DE 894 499 describes a refining apparatus that includes a rotating refiner cylinder having an inside wall against which several refiner rolls are pressed in order to refine the pulp. The refiner rolls are equipped with special circumferential grooves in order to achieve a certain desired refining effect. The refiner is not equipped for continuous operation.

What is needed in the art is a continuously operating method by which pulp or paper fibers are refined such that the strength properties of the produced paper are increased over that currently available. The increased dewatering resistance occurring should be less than with known refining methods.

Most of the known refiner drums are not suitable for this purpose since their effectiveness is based on the breaking of coarse particles. U.S. Pat. No. 2,719,463, for example, describes a refiner cylinder which can be utilized in the paper manufacturing industry. However, this refiner is for processing of the associated relatively coarse reject material. An apparatus of this type targets the size reduction of contaminants and is intended to leave the fibers, which are contained in the reject, unaltered.

### SUMMARY OF THE INVENTION

The new refining process operates in a way that the fiber characteristics are optimized, whereby the desired strength properties are developed without the freeness value being increased as is inherent with the conventional methods.

Comparative tests with long fiber pulp have demonstrated that, in order to achieve a tear length of 8 km with a bar type refining process, a 45° SR freeness value resulted, but only 18° SR with the method of the present invention. The required specific refining labor was lower by up to 50%.

It may be assumed that the structure of the fiber wall and the surface of the fibers are altered by the new refining method to such an extent that it contains an improved flexibility and bonding capability, without having to remove fibrils from the outer surface of the fibers. In addition, the production of fines, that is fiber fragments, is very limited.

If the method of the present invention is used for recycled fibers, the advantages may play a special role. Recycled fibers have already undergone at least one, and many times several refining actions so that avoiding any further size reduction of the fibers is welcome.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 illustrates a refining cylinder used by an embodiment of a method of the present invention;

FIG. 2 shows a refining roll used in the refining cylinder of FIG. 1;

FIG. 3 is a side view of the refiner apparatus of FIG. 1 with removed refining rolls;

FIG. 4 illustrates a component for the axial transportation of the fibrous stock used in the refiner apparatus of FIG. 3;

FIG. 5 illustrates an additional example of a refining cylinder with an altered flow direction;

FIG. 6 illustrates details of the refining cylinder of FIG. 5;

FIG. 7 illustrates an additional example of a refining cylinder with shorter refining rolls; and

FIG. 8 illustrates another embodiment of a refining cylinder with a conical refining drum.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

Referring now to the drawings, and, more particularly to FIGS. 1-8 there is depicted a refiner of the present invention including a refiner cylinder 1 in a horizontal position, equipped with several refiner rolls 2, located uniformly around its circumference. This illustration depicts five refiner rolls 2. In total there are 8, the other 3 have been omitted for the sake of clarity. The refiner rolls are each equipped with a larger number of refiner bars 3, which can also be referred to as knives. Refiner bars 3 and the surfaces of refiner cylinder 1, which are in contact with the stock, may consist of a material that is commonly used for this type of application, for example, hardened cast chromium steel, or a porous material, for example, sintered chromium steel. When carrying out the method, a refining zone is formed between refiner roll 2 and refiner cylinder 1 at the position where the inside wall of refiner cylinder 1 and refiner bars 3 are closest to each other. Refiner rolls 2 are pressed in radial direction against the inside wall of refiner cylinder 1 in order to generate the necessary refining force. For this purpose a spring 6 is indicated in FIG. 1. Alternatively, other types of pressure generating systems, for example, a pneumatic or hydraulic pressure cylinder may also be used. Refiner rolls 2 are mounted to rotate on a stationary axis of rotation. They may for example be fixed through two supports 7, which extend in an axial direction into the refiner cylinder. Refiner cylinder 1 is brought into rotation by a drive roller 4. Other drive possibilities however, are also feasible. Refiner rolls 2 do not require their own drive, since they are brought into rotation on the inside wall of refiner cylinder 1. This represents a substantial simplification of the refiner apparatus.

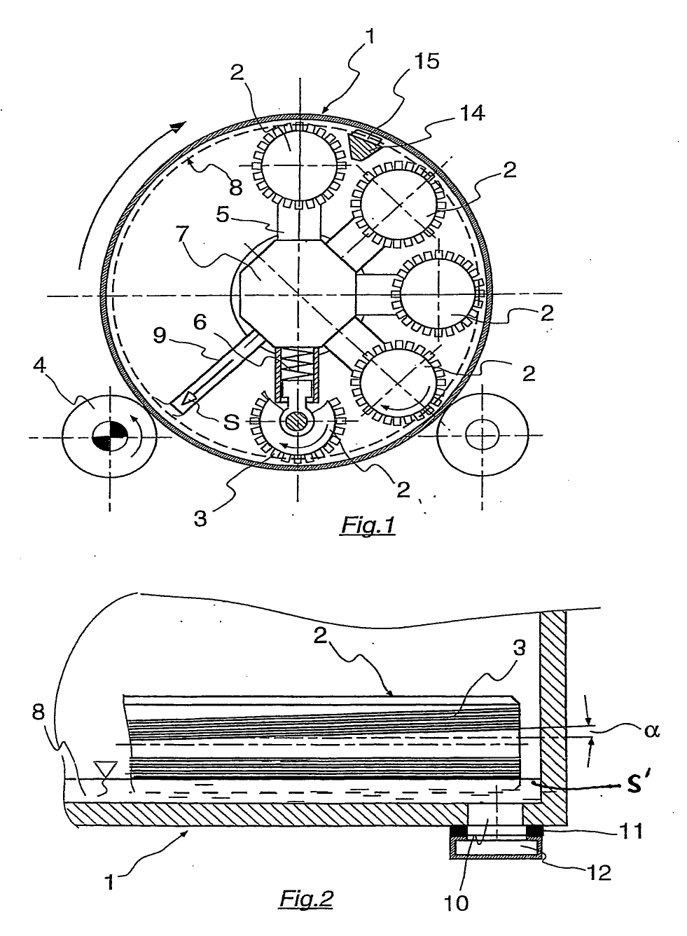

Aqueous suspended paper fibers are brought into the vicinity of the inside wall through one or several pipe lines 9. A pipe line 9 of this type is drawn schematically in a location where, for reasons of clarity, refiner rolls 2 are not depicted. Due to the rotational motion of refiner cylinder 1 the aqueous suspended paper fibers attach themselves, in the form of a fibrous stock layer 8, to the inside wall of refiner cylinder 1. Since pipe line 9, as well as support 7, are stationary it is easy to supply pipelines 9 centrally from support 7 with suspension S. Fibrous stock suspension S flows from pipeline 9 and is accelerated in a circumferential direction distributing itself on the inside wall of refiner cylinder 1. Suspensions then enter a refining zone, which is formed between a refiner roll 2 that is equipped with refiner bars 3, and the inside wall of refiner cylinder 1. It is normally desirable that fibrous stock suspensions be run through refining zones several times. Due to the centrifugal forces inside of refiner cylinder 1, a relatively uniform thickness is achieved for fibrous stock layer 8. As illustrated in FIG. 2 refined fibrous stock suspension S′ can be discharged through an outlet opening 10 on the circumference of refiner cylinder 1. Refined fibrous stock suspensions is discharged through a sealing element 11 into a stationary ring channel 12. Sealing element 11 or ring channel 12 can be arranged so that a connection to ring channel 12 exists only in a limited section of the circumference. In order to ensure a defined thickness of fibrous stock layer 8 is around refiner cylinder 1, a back pressure is created in ring channel 12. In the upper section of refiner cylinder 1 a cross bar 14 is positioned on which a number of guide vanes 15 are mounted. Guide vanes 15 dip into fibrous stock layer 8 and lead to a defined axial transportation.

Refiner bars 3 are generally arranged parallel to the axis. It is however also feasible that they are positioned at a sharp angle α relative to the center line of refiner roll 2 in order to promote, for example, the axial transportation of the fibrous stock suspension. Both these possibilities are indicated on a single refiner roll 2 shown in FIG. 2.

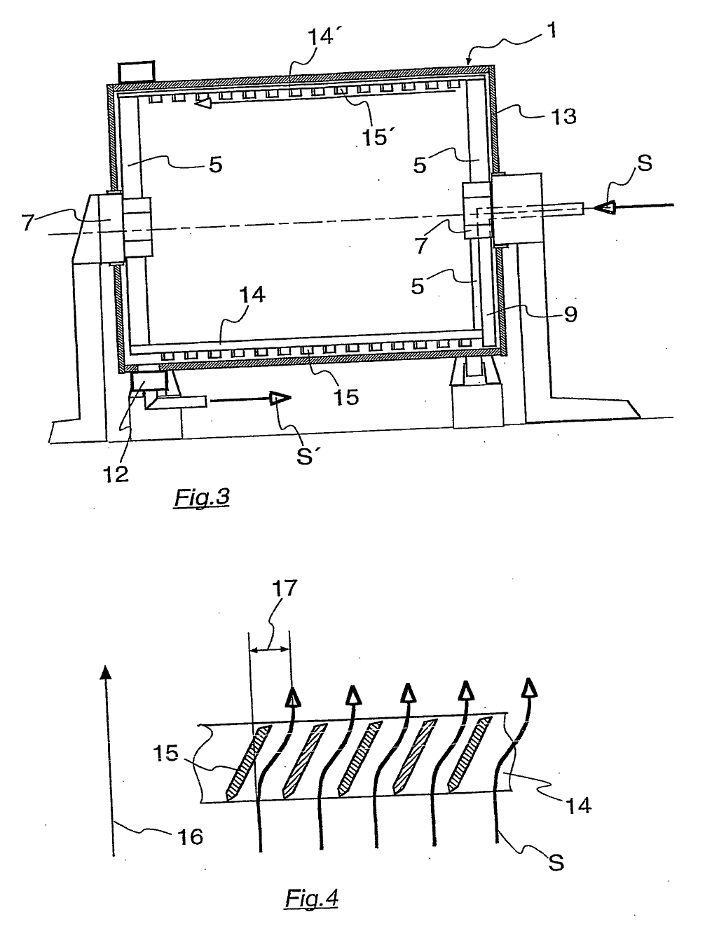

FIG. 3 illustrates a side view of a refiner suitable for realizing an embodiment of the present method. It includes a refiner cylinder 1 in a horizontal position. Several supports 5 can also be seen. However, for the sake of clarity the refiner rolls are not illustrated. In order to achieve a stock transportation that is as uniform as possible, the fibrous stock is directed in an axial direction from one face 13 of refiner cylinder 1 to the opposite side. The supply through pipe line 9 is shown on the right in this drawing. The discharge through ring channel 12 is on the left. Near the inside wall of refiner cylinder 1 one or several stationary cross bars 14 with guide vanes 15 are located. As illustrated in FIG. 4, guide vanes 15 are angled relative to circumferential direction 16, which results in an axial offset 17 of fibrous suspension S. One or several doctor bars 14′ can also be used to lift the fibrous stock layer 8 from the inside wall of refiner cylinder 1, loosen it and move it in an axial direction by way of guide vanes 15′ which are mounted on the opposite side.

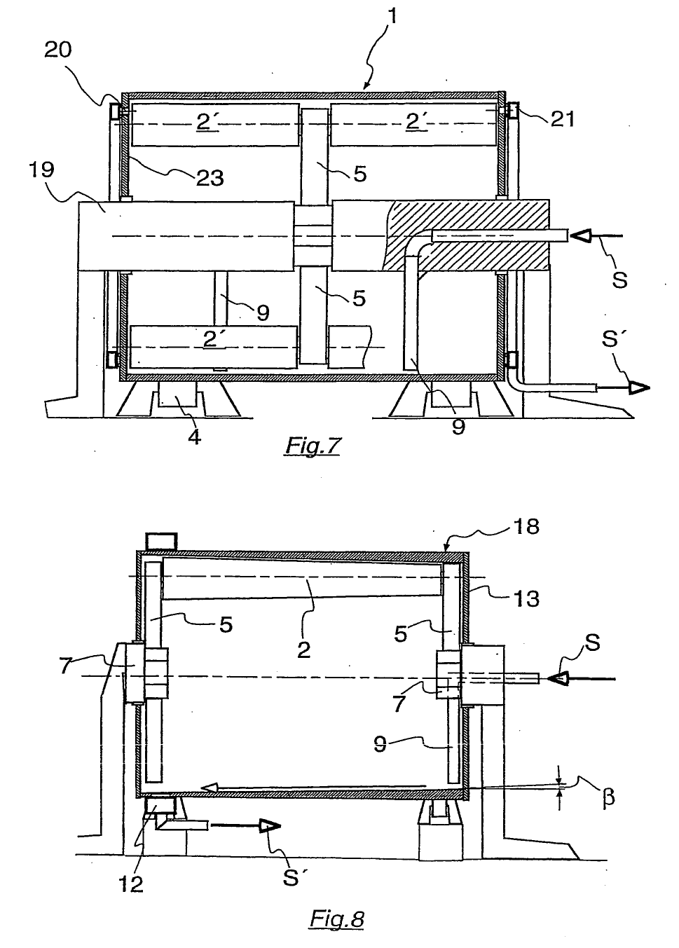

The refiner illustrated in FIG. 5 also shows a refiner cylinder 1 in a horizontal position on which several refiner rolls 2′ are positioned uniformly across the circumference. This illustration depicts three of a total of ten refiner rolls 2′ whose length is slightly shorter than half of the axial length of refiner cylinder 1 (s. FIG. 7). The devices which drive refiner cylinder 1 and generate the refining force are similar or identical to those already described. Refiner rolls 2′ rotate on a stationary rotational axis. They may for example be cantilevered in a support 6, which is mounted on a yoke 19 that extends through the refiner cylinder in an axial direction.

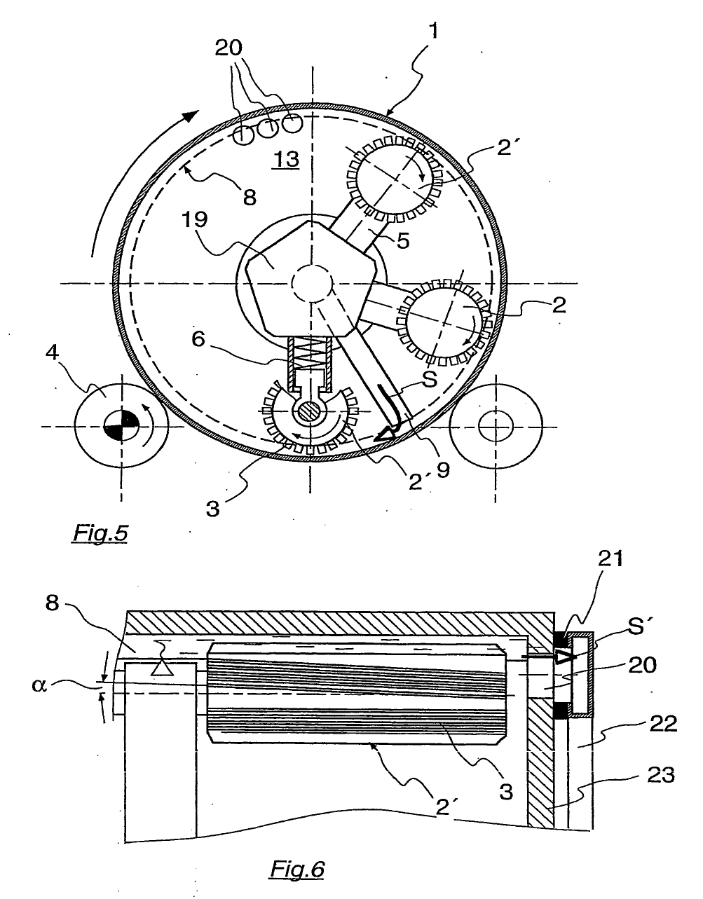

The aqueous suspended paper fibers are fed into the refiner, where they are distributed and treated. In order to produce a continuously uniform suspension stream it is advantageous to provide overflow openings 20 in one, or preferably both faces 23 of refiner cylinder 1. Overflow openings 20 can be distributed equally around the circumference. As is the case with a weir, their radial distance from the inside wall of refiner cylinder 1 essentially determines the height with which liquid layer 8 can develop. As shown in FIG. 6, refined fibrous stock suspension S′ can be discharged through a sealing element 21 into a stationary ring channel 22. Sealing element 21 is arranged so that there is a connection with ring channel 22 only in a limited section of the circumference, for example, immediately before the location where pipeline 9 discharges. In order to decrease the cost of a relatively large sealing element 21 a rotating line, which is not depicted here, could be used to transport the refined fibrous stock to a location that could be sealed more easily.

Refiner bars 3 are generally located parallel to the axis. Alternatively, it is also feasible that they are positioned at a sharp angle α relative to the center line of refiner roll 2′ in order to promote, for example, the axial transportation of the fibrous stock suspension. Both these possibilities are indicated on a single refiner roll 2′ in FIG. 6.

FIG. 7 shows a side view of the refiner depicted in FIG. 5. It includes a horizontally positioned refiner cylinder 1. It is shown that two refiner rolls 2′ respectively are mounted in a cantilevered manner in a support 5. This promotes a simple design with few components to interfere with the suspension flow. In addition, the axial extension of refiner rolls 2′ can be kept relatively short. This also contributes to a uniform refining of the fibers. The addition of fibrous stock suspension S occurs here through two axially distanced pipelines 9.

In contrast to what has been shown previously, the axial transportation of fibrous stock suspensions in the refiner drum can be carried out with a conical refiner drum 18, as illustrated schematically in FIG. 8. Relative to the axial direction, its inside wall has an inclined angle β, which is preferably smaller than 5°. Due to the centrifugal forces at work during rotation of the refiner cylinder, an axial force component is created. Based on these steps, the stationary transport elements, such as cross bar 14 or doctor bar 14′ which are depicted in FIG. 1, 3 or 4, may possibly be eliminated.

1-22. (canceled)

23. A method for refining aqueous suspended fibers, the fibers being one of paper fibers and pulp fibers, comprising the steps of:
leading the aqueous suspended fibers through at least one refining zone which is located between an inside wall of a rotating refiner drum and at least one refiner roll, said refiner roll rotating in association with said refiner drum;
pressing said refiner roll and said refiner drum against each other thereby causing a mechanical refining force to be transferred to the fibers so that strength properties of paper produced therefrom are altered;
forming a fibrous stock layer on said inside wall of said rotating refiner by the aqueous suspended paper fibers;
temporarily attaching said fibrous stock layer to said inside wall due to rotation;
supplying a continuous flow of liquid with the aqueous suspended paper fibers to said fibrous stock layer; and
discharging said liquid from said fibrous stock layer.

24. The method of claim 23, wherein said refiner roll is equipped with bars whose axial extension relative to an axial extension of said refiner roll is at an angle (α) of between 0° and 45°.

25. The method of claim 24, wherein said inside wall of said refiner drum is not equipped with refiner bars that engage between refiner bars of said refiner roll.

26. The method of claim 25, wherein a relative speed between said inside wall of said refiner drum and said refiner rolls viewed in a circumferential direction of said refiner drum at a location where two refiner rolls are closest to each other in said refiner zone is adjusted to a maximum of 10% of a circumferential speed of said inside wall of said refiner cylinder.

27. The method of claim 23, wherein said refiner roll and said refiner drum are pressed together with such force that line forces of between approximately 5 and 30 N/mm are created.

28. The method of claim 27, wherein said line force is at least 15 N/mm.

29. The method of claim 23, wherein said refiner drum is rotated with a circumferential speed of said inside wall of between approximately 20 m/s and 40 m/s.

30. The method of claim 29, wherein said circumferential speed is approximately 30 m/s.

31. The method of claim 23, wherein a centerline of said refiner drum relative to a horizontal position is adjusted to be an angle of between approximately 0° and 5°.

32. The method of claim 31, wherein said centerline of said refiner drum is in a horizontal position.

33. The method of claim 23, further comprising the step of continuously transporting the paper fibers within said fibrous stock layer in an axial direction from one end of said refiner drum to another end of said refiner.

34. The method of claim 33, wherein the aqueous suspended fibers in a fibrous stock suspension are supplied through at least one pipeline that feeds into said refiner drum on one face side, said suspended fibers are refined and removed through at least one outlet opening on an opposite face of said refiner drum.

35. The method of claim 34, wherein said fibrous stock suspension of said fibrous stock layer is supplied from at least two axially distanced locations inside said refiner drum.

36. The method of claim 35, wherein said fibrous stock suspension is supplied through pipelines which discharge near said fibrous stock layer.

37. The method of claim 35, wherein said locations are distributed uniformly along an axial extension of said refiner drum.

38. The method of claim 23, wherein a refined paper fibrous suspension is removed from said refiner drum through at least one overflow opening which is located on at least one of a plurality of faces of said refiner drum.

39. The method of claim 38, wherein said at least one overflow opening defines the thickness of said fibrous stock layer.

40. The method of claim 23, further comprising the step of adjusting said fibrous stock layer to a consistency of between approximately 2 to 6% in said refining zone.

41. The method of claim 23, wherein said refiner drum is a refiner cylinder.

42. The method of claim 41, further comprising the step of axially transporting said fibrous stock layer along a length of said refiner cylinder by way of at least one transport device inside said refiner cylinder.

43. The method of claim 42, wherein said transport device includes a stationary cross bar equipped with guide vanes that dip into said fibrous stock layer.

44. The method of claim 42, wherein said transport device includes a stationary doctor bar equipped with guide vanes that dip into said fibrous stock layer.

45. The method of claim 23, wherein said inside wall of said refiner drum is conical in form thereby defining a conical refiner drum.

46. The method of claim 45, wherein said conical refiner drum has an inclined angle (β) of between approximately 1° and 5°.
